(19) United States
(12) Patent Application Publication
(10) Pub. No.: US 2022/0253396 A1
(43) Pub. Date: Aug. 11, 2022

(54) PORT CONFIGURATION IDENTIFICATION SYSTEM

(71) Applicant: Dell Products L.P., Round Rock, TX (US)

(72) Inventor: Ming Chung Chow, Pleasanton, CA (US)

(21) Appl. No.: 17/173,414

(22) Filed: Feb. 11, 2021

(51) Int. Cl. G06F 13/40

(52) U.S. Cl. CPC G06F 13/4068

(57) ABSTRACT

A port configuration identification system includes a base. A port configuration identification information surface is included on the base and includes port configuration identification information corresponding to a port configuration available for a port on a computing device. A computing device coupling feature is included on the base and is configured to couple to the computing device to secure the base relative to the computing device and adjacent the port such that the port configuration identification information surface is positioned adjacent the port.

### BACKGROUND

The present disclosure relates generally to information handling systems, and more particularly to identifying the configuration of ports on information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switch devices, sometimes include subsets of their ports that are configurable to operate differently from other ports on the switch device. For example, some switch devices (e.g., 12.8 Tb Ethernet switch devices provided with a 1 Rack Unit (RU) height and configured with 32 400 GbE ports) may be configured to transmit electrical and/or optical communications according to the Pulse Amplitude Modulation 4-level (PAM4) format at speeds of 50 Gbps/lane (50 G), and may also be configured to utilize Quad Small Form-factor Pluggable—Double Density (QSFP-DD) transceiver devices that require relatively more power from their connected ports than is provided by the rest of the ports on the switch device (e.g., a QSFP-DD transceiver device connected to a switch device may require 15 watts of power from its connected port rather than the 7 watts of power many of the other ports on that switch device are configured to provide). As such, the ports on those switch devices that will connect to the QSFP-DD transceiver devices may be configured to provide the increased power (relative to the other ports on that switch device) required by the QSFP-DD transceiver device, and it is desirable to identify those higher-power-configured ports to users.

However, the use of such higher-power-configured ports on switch devices can give rise to thermal cooling issues, particularly adjacent the front panel of the switch device that includes the ports to which the QSFP-DD transceiver devices connect. Furthermore, there is very little space (e.g., area) on the front panel of the switch device to provide direct markings and/or other visual aids for use in identifying the higher-power-configured ports, as that space is already utilized by essential switch components and/or markings (e.g., Light Emitting Devices (LEDs), port numbers, air venting apertures, etc.). As such, conventional switch devices tend to limit the number of ports that may be configured to provide higher power and support QSFP-DD transceiver devices in order to ensure safe switch device operation according to power specifications, as well as ensure proper cooling of the switch device components in different airflow configurations (e.g., a “front-to-back” switch device airflow configuration or a “back-to-front” switch device airflow configuration, either of which may be configured for a switch device depending on its placement in a rack or other chassis). Conventional port configuration identification solutions for such situations include coloring the higher-power configurable ports differently from the lower power provisioning ports. However, the QSFP-DD transceiver devices and/or cabling coupled to the ports on the switch device will often obscure the differently colored ports, eliminating their associated port configuration identification benefits.

Accordingly, it would be desirable to provide a port configuration identification system that addresses the issues discussed above.

### SUMMARY

According to one embodiment, an Information Handling System (IHS) includes a chassis; a processing system that is housed in the chassis; a port that is coupled to the processing system and that is accessible on a surface of the chassis; and a port configuration identification system including: a base; a port configuration identification information surface that is included on the base and that include port configuration identification information corresponding to a port configuration available for the port; and a chassis coupling feature that is included on the base and that is coupled to the chassis to secure the base relative to the chassis and adjacent the port such that the port configuration identification information surface is positioned adjacent the port.

### BRIEF DESCRIPTION OF THE DRAWINGS

FIG. 1 is a schematic view illustrating an embodiment of an Information Handling System (IHS).

FIG. 2A is a schematic view illustrating an embodiment of a switch device that may utilize the port configuration identification system of the present disclosure.

FIG. 2B is a front schematic view illustrating an embodiment of the switch device of FIG. 2A.

FIG. 2C is a front perspective view illustrating an embodiment of the switch device of FIGS. 2A and 2B.

FIG. 2D is a front perspective view illustrating an embodiment of a port on the switch device of FIG. 2C.

FIG. 3A is a perspective view illustrating an embodiment of a port configuration identification device.

FIG. 3B is a front view illustrating an embodiment of the port configuration identification device of FIG. 3A.

FIG. 4 is a perspective view illustrating an embodiment of a port configuration identification device.

FIG. 5 is a perspective view illustrating an embodiment of a port configuration identification device.

FIG. 6 is a flow chart illustrating an embodiment of a method for identifying a port configuration.

FIG. 7A is a side view illustrating an embodiment of the port configuration identification device of FIGS. 3A and 3B being coupled to the switch device of FIGS. 2A, 2B, 2C, and 2D.

FIG. 7B is a perspective view illustrating an embodiment of the port configuration identification device of FIGS. 3A and 3B coupled to the switch device of FIGS. 2A, 2B, 2C, and 2D.

FIG. 8A is a perspective view illustrating an embodiment of the port configuration identification device of FIG. 4 being coupled to the switch device of FIGS. 2A, 2B, 2C, and 2D.

FIG. 8B is a perspective view illustrating an embodiment of the port configuration identification device of FIG. 4 coupled to the switch device of FIGS. 2A, 2B, 2C, and 2D.

FIG. 9A is a side view illustrating an embodiment of the port configuration identification device of FIG. 5 being coupled to the switch device of FIGS. 2A, 2B, 2C, and 2D.

FIG. 9B is a perspective view illustrating an embodiment of the port configuration identification device of FIG. 5 coupled to the switch device of FIGS. 2A, 2B, 2C, and 2D.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

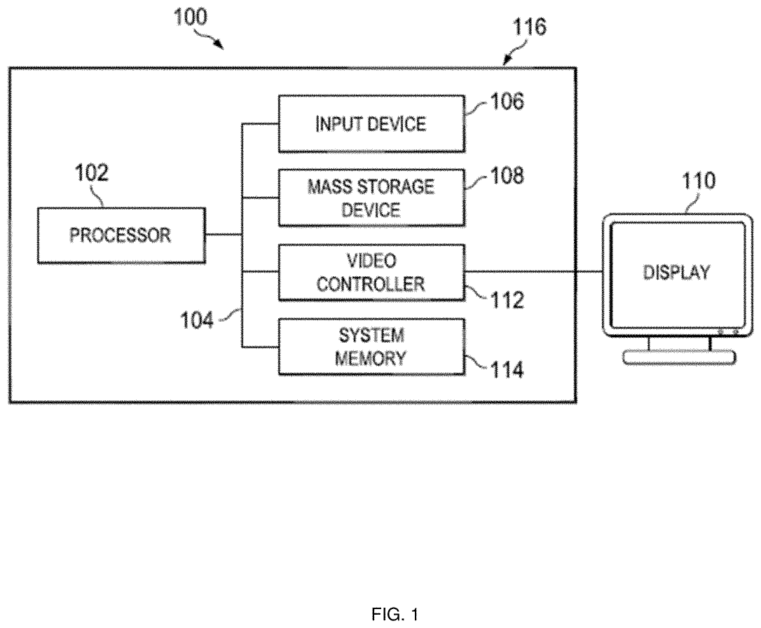

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

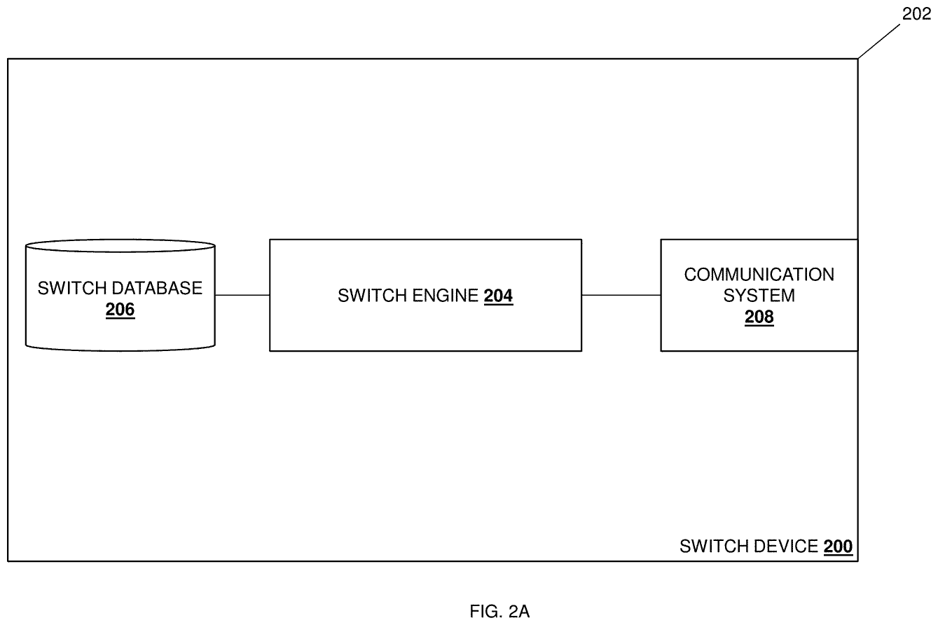

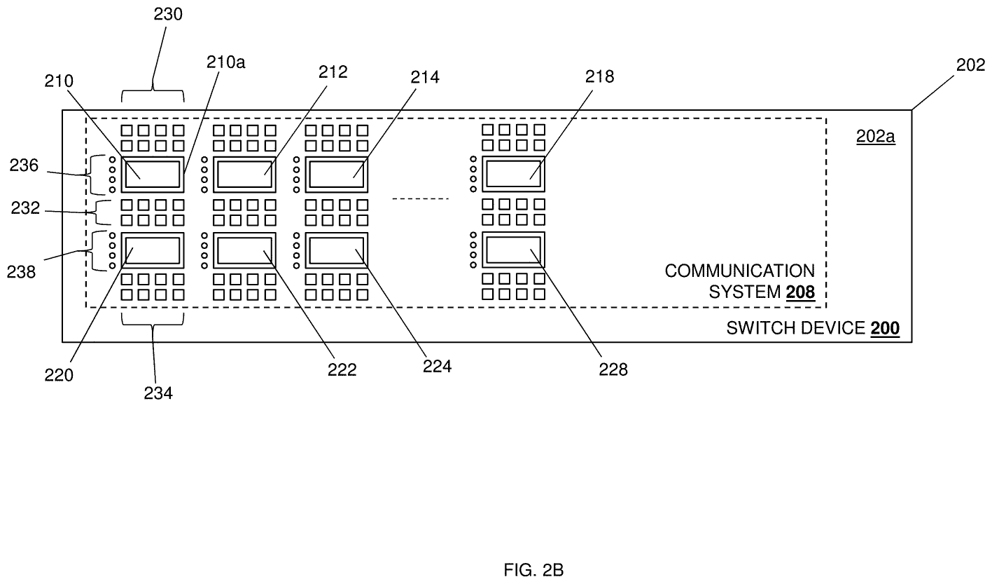

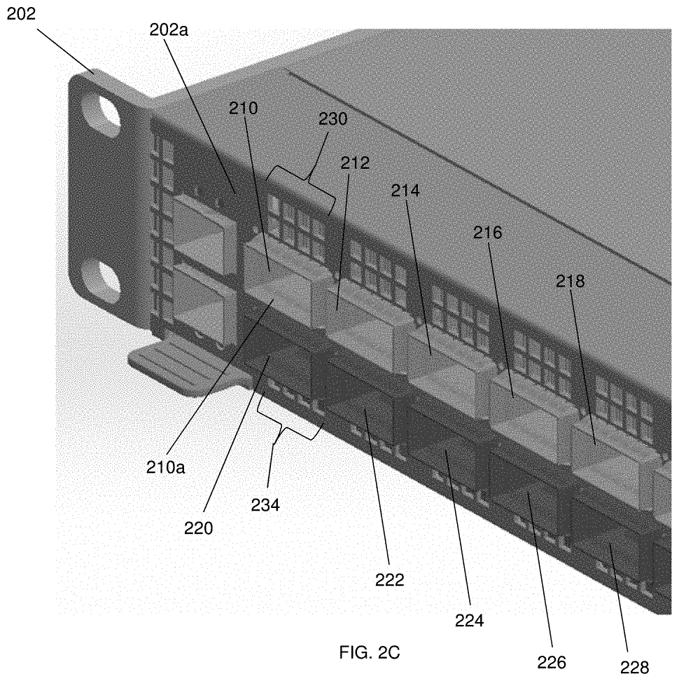

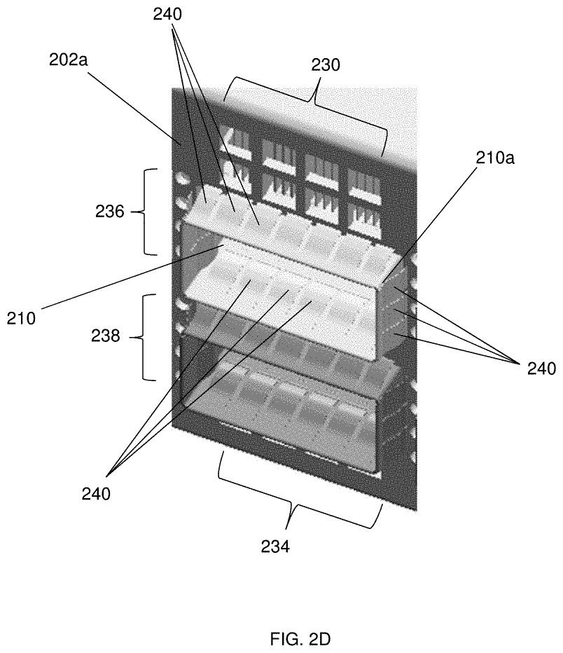

Referring now to FIG. 2A, an embodiment of a switch device 200 is illustrated that may utilize the port configuration identification system of the present disclosure. As such, the switch device 200 may be provided by the IHS 100 discussed above with reference to FIG. 1, and/or may include some or all of the components of the IHS 100, and in the specific examples discussed below is provided by an Ethernet switch device that allows a subset of its ports to be configured to provide relatively higher power than the rest of its ports. However, while illustrated and discussed as being provided by a switch device, one of skill in the art in possession of the present disclosure will recognize that the functionality of the switch device 200 discussed below may be provided by any computing devices that are configured to operate similarly as the switch device 200 discussed below. In the illustrated embodiment, the switch device 200 includes a chassis 202 that houses the components of the switch device 200, only some of which are illustrated and discussed below. For example, the chassis 202 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a switch engine 204 that is configured to perform the functionality of the switch engines and/or switch devices discussed below.

The chassis 202 may also house a storage system (not illustrated, but which may include the storage 108 discussed above with reference to FIG. 1) that is coupled to the switch engine 204 (e.g., via a coupling between the storage system and the processing system) and that includes a switch database 206 that is configured to store any of the information (e.g., forwarding tables, etc.) utilized by the switch engine 204 discussed below. The chassis 202 may also house a communication system 208 that is coupled to the switch engine 204 (e.g., via a coupling between the communication system 208 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. FIGS. 2B, 2C, and 2D illustrate specific examples of the chassis 202 and communication system 208 on the switch device 200, and one of skill in the art in possession of the present disclosure will appreciate that other chassis and/or communication system features will fall within the scope of the present disclosure as well.

For example, the communication system 208 in the switch device 200 may include a front surface 202a on the chassis 202, with the communication system 208 including a plurality of ports 210, 212, 214, 216, 218, 220, 222, 224, 226, and 228 located on the front surface 202a of the chassis 202. For example, the port 210 is illustrated in FIGS. 2B and 2C as including an ElectroMagnetic Interference (EMI) “finger”/cage 210a that extends from the front surface 202a of the chassis 202, and while not provided with element numbers, one of skill in the art in possession of the present disclosure will recognize that each of the ports 212-228 include similar EMI fingers/cages as well. FIGS. 2B and 2C illustrate how a plurality of airflow apertures are defined by the base 202 and extend through the front surface 202a of the base 202, including a first subset of airflow apertures 230 (e.g., eight square airflow apertures oriented in a 2×4 grid) that are located between the port 210 and a top surface of the base 202, a second subset of airflow apertures 232 (e.g., eight square airflow apertures oriented in a 2×4 grid) that are located between the port 210 and the port 220, a third subset of airflow apertures 234 (e.g., eight square airflow apertures oriented in a 2×4 grid) that are located between the port 220 and a bottom surface of the base 202, a fourth subset of airflow apertures 236 (e.g., a column of four circular airflow apertures) that are located between the port 210 and a side surface of the base 202, and a fifth subset of airflow apertures 238 (e.g., a column of four circular airflow apertures) that are located between the port 220 and the side surface of the base 202. Furthermore, while not provided with element numbers, one of skill in the art in possession of the present disclosure will recognize that similar subsets of airflow apertures are provided adjacent the ports 212/222, 214/224, and up to 218/228. As discussed below, the use of the front surface 202a of the chassis 202 for airflow apertures, port numbering (not illustrated), port LEDs, and/or other essential switch device features leaves little room on the front surface 202a of the chassis 202 to identify port configurability of any of the ports 210-228.

Furthermore, FIG. 2D illustrates how the EMI “finger”/cage 210a on the port 210 may include port configuration identification system base securing features 240 that extend from the walls of the EMI “finger”/cage 210a and that may be provide by resilient members (e.g., springs) that are each configured to provide a force that is directed away from the EMI “finger”/cage 210a when compressed towards the EMI “finger”/cage 210a, discussed in further detail below. Furthermore, while not provided with element numbers, one of skill in the art in possession of the present disclosure will recognize that similar port configuration identification system base securing features may be provided on the EMI “fingers”/cages provided with each of the ports 212-228 as well. Furthermore, while a specific switch device 200 has been illustrated, one of skill in the art in possession of the present disclosure will recognize that switch devices (or other computing devices operating according to the teachings of the present disclosure in a manner similar to that described below for the switch device 200) may include a variety of components and/or component configurations for providing conventional switch device functionality, as well as the functionality discussed below, while remaining within the scope of the present disclosure as well.

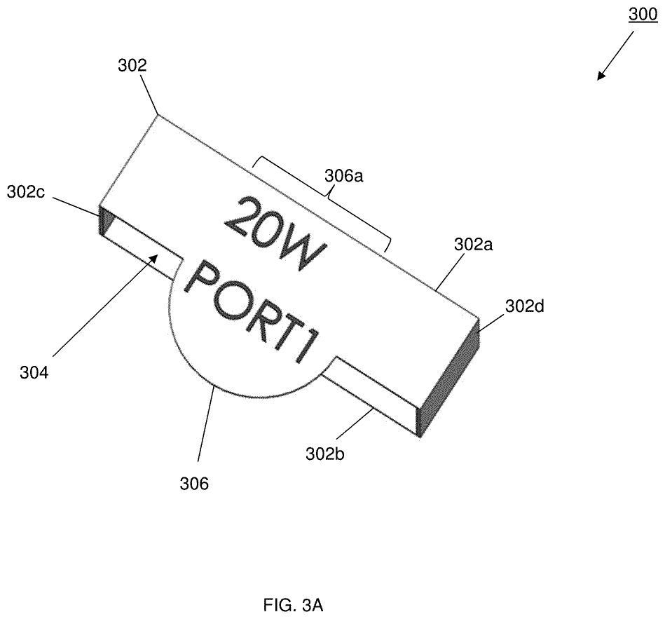

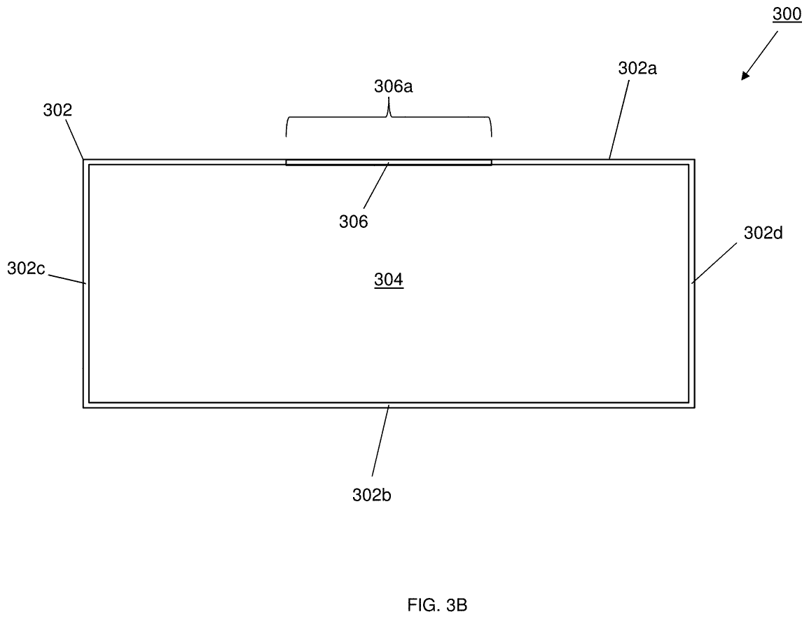

Referring now to FIGS. 3A and 3B, an embodiment of a port configuration identification system 300 is illustrated. In the illustrated embodiment, the port configuration identification system 300 includes a base 302 that includes a top wall 302a, a bottom wall 302b that is located opposite the base 302 from the top wall 302a, and a pair of side walls 302c and 302d that are spaced apart from each other, located opposite each other on the base 302, and that each extend between the top wall 302a and the bottom wall 302b. A device coupling feature 304 is included on the base 302 and, in the illustrated embodiment, includes an EMI “finger”/cage channel that is defined by the base 302 between the top wall 302a, the bottom wall 302b, and the side walls 302c and 302d, and that extends through the base 302. The top wall 302a provides a tab 306 and includes a port configuration identification information surface 306a that is located on portions of the top wall 302a and the tab 306. The port configuration identification information surface 306a includes port configuration identification information corresponding to a port configuration that is available for a port (e.g., “PORT 1”) on the switch device 200, and in the illustrated embodiment that port configuration identification information identifies a port power configuration for that port on the switch device 200 that allows that port to provide 20 watts of power, discussed in further detail below. However, while specific port configuration identification information for a port power configuration is illustrated and described in the examples below, one of skill in the art in possession of the present disclosure will appreciate that the port configuration identification information may identify other port configurations while remaining within the scope of the present disclosure as well.

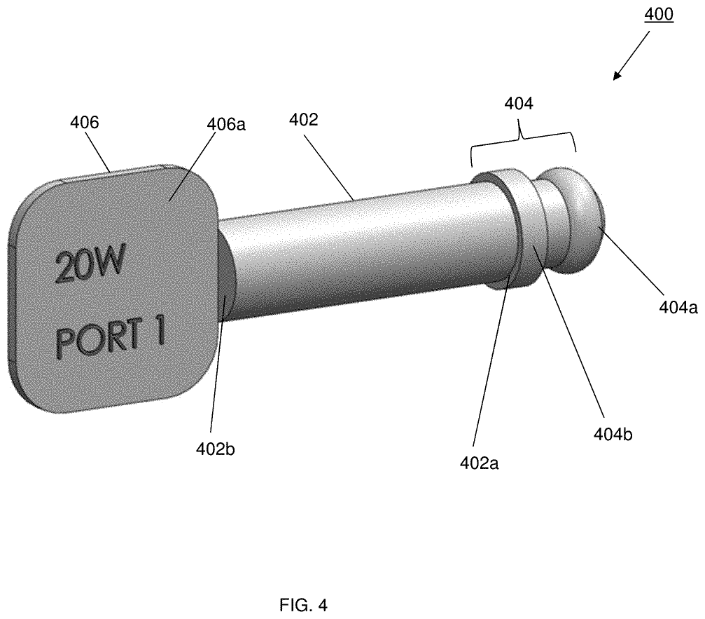

Referring now to FIG. 4, an embodiment of a port configuration identification system 400 is illustrated. In the illustrated embodiment, the port configuration identification system 400 includes a cylindrical base 402 that includes a front end 402a and a rear end 402b that is located opposite the cylindrical base 402 from the front end 402a. A device coupling feature 404 is included on the base 402 and, in the illustrated embodiment, extends from the front end 402a of the base 402 and includes a device engagement element 404a an aperture engagement element 404a and a device stop member 404b, the functionality of which is discussed further below. A handle 406 extends from the rear end 402b of the cylindrical base 402 and includes a port configuration identification information surface 406a. The port configuration identification information surface 406a includes port configuration identification information corresponding to a port configuration that is available for a port (e.g., “PORT 1”) on the switch device 200, and in the illustrated embodiment that port configuration identification information identifies a port power configuration for that port on the switch device 200 that allows that port to provide 20 watts of power, discussed in further detail below. However, while specific port configuration identification information for a port power configuration is illustrated and described in the examples below, one of skill in the art in possession of the present disclosure will appreciate that the port configuration identification information may identify other port configurations while remaining within the scope of the present disclosure as well.

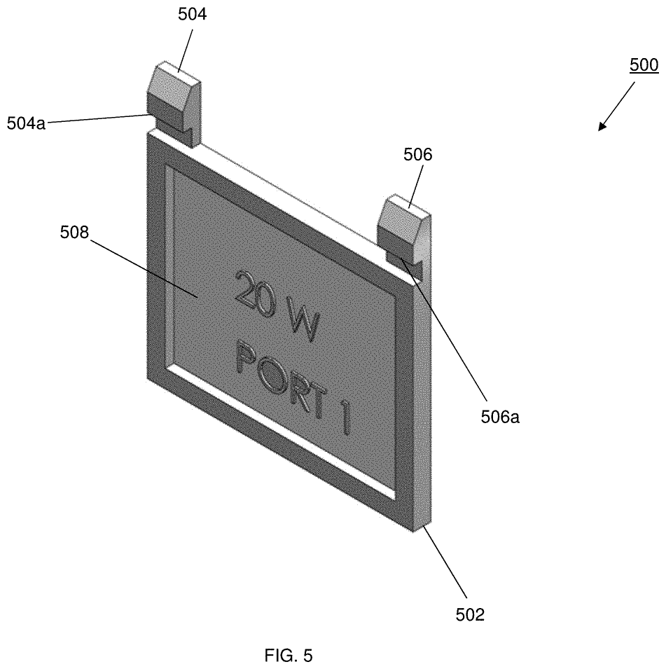

Referring now to FIG. 5, an embodiment of a port configuration identification system 500 is illustrated. In the illustrated embodiment, the port configuration identification system 500 includes a rectangular base 502. A device coupling feature is included on the base 502 and, in the illustrated embodiment, includes a pair of aperture engagement elements 504 and 506 that extend from a top edge of the base 502 in a spaced apart orientation from each other and adjacent opposite sides of the base 502, with the aperture engagement element 504 including a securing feature 504a, and the aperture engagement element 506 including a securing feature 506a. The base 502 also includes a port configuration identification information surface 508. The port configuration identification information surface 508 includes port configuration identification information corresponding to a port configuration that is available for a port (e.g., “PORT 1”) on the switch device 200, and in the illustrated embodiment that port configuration identification information identifies a port power configuration for that port on the switch device 200 that allows that port to provide 20 watts of power, discussed in further detail below. However, while specific port configuration identification information for a port power configuration is illustrated and described in the examples below, one of skill in the art in possession of the present disclosure will appreciate that the port configuration identification information may identify other port configurations while remaining within the scope of the present disclosure as well. Furthermore, while a variety of different port configuration identification systems having specific features have been described, one of skill in the art in possession of the present disclosure will recognize that the port configuration identification system of the present disclosure may be provided with other configurations that will fall within the scope of the present disclosure as well.

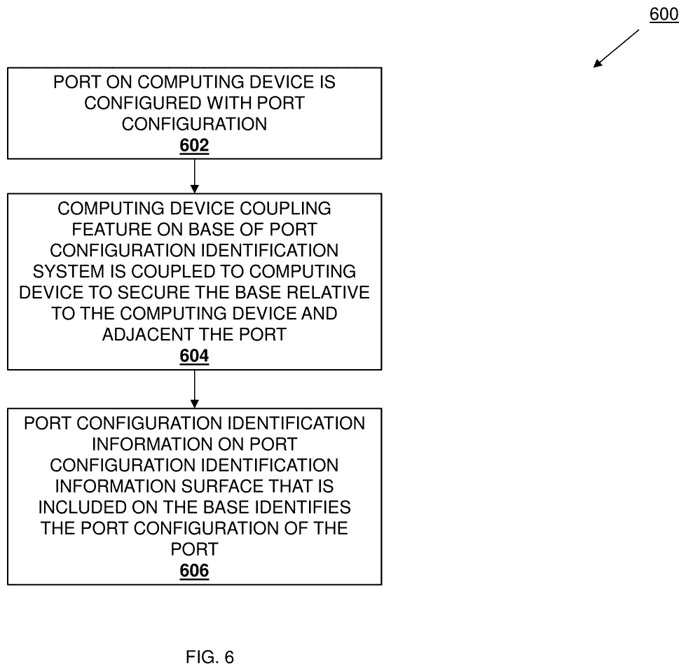

Referring now to FIG. 6, an embodiment of a method 600 for identifying a port configuration is illustrated. As discussed below, the systems and methods of the present disclosure provide a flexible, easy to install/configure port configuration identification system that provides a visual aid for identifying port configurations of ports while not compromising (or substantially comprising) airflow to the port (or the device that includes the port). For example, the port configuration identification system of the present disclosure may include a base. A port configuration identification information surface is included on the base and includes port configuration identification information corresponding to a port configuration available for a port on a computing device. A computing device coupling feature is included on the base and is configured to couple to the computing device to secure the base relative to the computing device and adjacent the port such that the port configuration identification information surface is positioned adjacent the port. As such, the systems and methods of the present disclosure allow ports with different port configurations on a device to be identified without the limitations of conventional port configuration identification systems.

The method 600 begins at block 602 where a port on a computing device is configured with a port configuration. In an embodiment, at block 602, a port on the switch device 200 may be configured with a port configuration. In the examples below, the port 210 on the switch device 200 is configured with the port configuration, but one of skill in the art in possession of the present disclosure will appreciate that any of the ports 212-228 may be configured in a similar manner while remaining within the scope of the present disclosure as well. In the specific examples provided below, all of the ports on the switch device 200 may be capable of providing a first amount of power (e.g., 15 watts of power), while a subset of ports (including the port 210 in the examples below) are configurable with a first port power configuration that provides the first amount of power, or with a second port power configuration that provides a second amount of power (e.g., 20 watts of power) that is different than the first amount of power. However, while port power configurations that configure ports to provide specific power amounts are discussed below, one of skill in the art in possession of the present disclosure will appreciate that other port configurations (e.g., port power configurations that provide different power amounts (e.g., 7 watts of a power and 15 watts of power), port configurations not involving power provisioning, etc.) may be identified according to the teachings of the present disclosure while remaining within its scope.

Furthermore, one of skill in the art in possession of the present disclosure will appreciate that cooling systems (not illustrated) in the switch device 200 may be configurable to provide different airflow configurations. For example, fan devices in the cooling system for the switch device 200 may be configurable to provide a “normal”/“front-to-back” airflow configuration (e.g., in which the airflow enters the switch device 200 via its front surface 202a and exits the switch device 200 via its rear surface), or a “reversed”/“back-to-front” airflow configuration (e.g., in which the airflow enters the switch device 200 via its rear surface and exits the switch device 200 via its front surface 202a). One of skill in the art in possession of the present disclosure will appreciate that the different airflow configurations may provide different cooling capabilities (e.g., the “normal”/“front-to-back” airflow configuration may provide a higher level of cooling than the “reversed”/“back-to-front” airflow configuration discussed above), and the ability to meet cooling requirements for the switch device 200 with port configured with the different port power configurations discussed above may depend on which airflow configuration is provided for the cooling system in the switch device 200.

For example, some switch devices may only have their cooling requirements met with a limited number of ports (e.g., two ports, four ports, etc.) configured to provide relatively higher power while the cooling system is configured with the “normal”/“front-to-back” airflow configuration, and may not be able to meet its cooling requirements when any ports configured to provide relatively higher power while the cooling system is configured with the “reversed”/“back-to-front” airflow configuration. As such, the port configuration at block 602 may include configuring the cooling system with an airflow configuration, and configuring a limited number of ports on the switch device with the port power configuration that provides relatively higher power (to its connected device, not illustrated). As such, in some embodiments, the port configuration identification system of the present disclosure may be provided with a subset of ports on the switch device 200 that have been provided a different port configuration than the remaining ports on the switch device 200 (e.g., a port power configuration that causes those ports to provide relatively higher power than the remaining ports on the switch device 200).

In some embodiments of block 602, the configuration of the port at block 602 may be performed by a manufacturer of the switch device 200, and thus the switch device 200 may be provided to a user of the switch device 200 with one or more ports configured with a different port configuration that the remaining ports on the switch device 200. However, in other embodiments, the configuration of the port at block 602 may be performed by a user of the switch device 200, and thus one or more ports on the switch device 200 may have its configuration changed such that it is configured with a different port configuration than the remaining ports on the switch device 200. However, while two port configuration scenarios are described, one of skill in the art in possession of the present disclosure will appreciate that ports may be configured for a variety of reasons and in a variety of situations, any of which will fall within the scope of the present disclosure as well.

The method 600 then proceeds to block 604 where a computing device coupling feature on a base of a port configuration identification system is coupled to the computing device to secure the base relative to the computing device and adjacent the port. In the examples below, the port 210 was configured at block 602 with a port power configuration that causes the port 210 to provide 20 watts of power, rather than the 15 watts of power the remaining ports 212-228 on the switch device 200 are configured to provide. As such, in the embodiments provided below, the port configuration identification system of the present disclosure is selected or configured to include power configuration identification information on its port configuration identification information surface that identifies the port 210 (“PORT 1” in the examples below) and its corresponding port power configuration (“20 W” in the examples below).

In some examples, the switch device 200 may be provided with multiple port configuration identification systems that identify the different ports (e.g., “PORT 1”, “PORT 2”, and up to “PORT N”) and that include power configuration identification information (e.g., “7 W”, “15 W”, “20 W”, and/or any other available port power configurations) on their port configuration identification information surfaces, which allows the appropriate port configuration identification system to be selected (e.g., the port configuration identification system that identifies “PORT 1” and “20 W” in the examples below) for use during the method 600. In other examples, the switch device 200 may be provided with port configuration identification systems that have blank port configuration identification information surfaces, along with stickers that identify the different ports (e.g., “PORT 1”, “PORT 2”, and up to “PORT N”) and that include power configuration identification information (e.g., “7 W”, “15 W”, “20 W”, and/or any other available port power configurations), which allows any port configuration identification system to be configured with the appropriate stickers (e.g., stickers that include the port configuration identification information that identifies “PORT 1” and “20 W” in the examples below) for use during the method 600. However, while two different techniques for providing port configuration identification systems that describe the port configuration for a particular port have been described, one of skill in the art in possession of the present disclosure will appreciate that the port configuration identification system of the present disclosure may be provided to identify a port configuration for a particular port in a variety of manners that will fall within the scope of the present disclosure as well.

Similarly as discussed above, in some embodiments of block 604, the coupling of the port configuration identification system to the switch device 200 at block 604 may be performed by a manufacturer of the switch device 200, and thus the switch device 200 may be provided to a user of the switch device 200 with the port configuration of one or more ports identified via the port configuration identification system of the present disclosure. However, in other embodiments, the coupling of the port configuration identification system to the switch device 200 at block 604 may be performed by a user of the switch device 200, and thus the user may identify the port configuration of one or more ports on the switch device 200 via the port configuration identification system of the present disclosure and subsequent to receiving the switch device 200. However, while two port configuration identification scenarios are described, one of skill in the art in possession of the present disclosure will appreciate that ports may have their port configuration identified using the port configuration identification system of the present disclosure in a variety of situations, any of which will fall within the scope of the present disclosure.

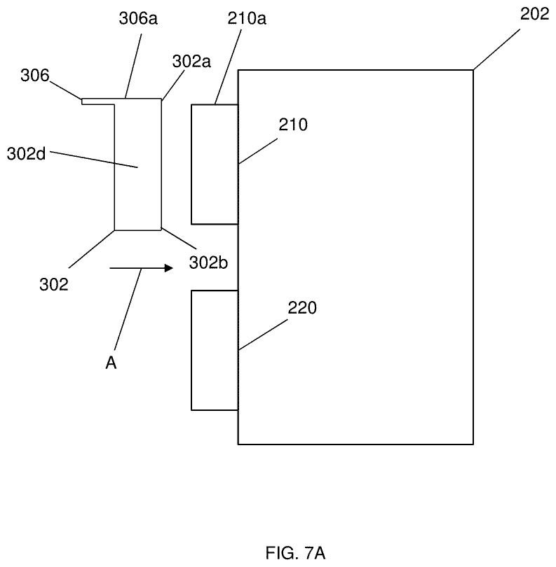

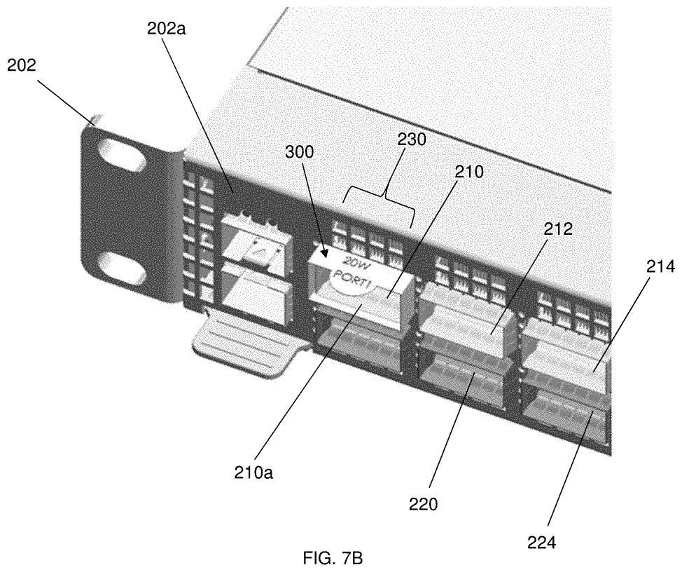

With reference to FIGS. 7A and 7B, in an embodiment of block 604, the port configuration identification system 300 discussed above with reference to FIGS. 3A and 3B may be positioned (e.g., via a user grasping the side walls 302c and 302d on the base 302) adjacent the port 210 such that the tab 306 on the base 302 is located opposite the base 302 from the port 210, and the device coupling feature 304 defined by the base 302 is aligned with the EMI “finger”/cage 210a on the port 210, as illustrated in FIG. 7A. The port configuration identification system 300 may then be moved towards the port 210 in a direction A such that the EMI “finger”/cage 210a on the port 210 enters the device coupling feature 304 defined by the base 302. With reference to FIGS. 2D and 7B, as the EMI “finger”/cage 210a on the port 210 enters the device coupling feature 304 defined by the base 302, the port configuration identification system base securing features 240 on the EMI “finger”/cage 210a on the port 210 are compressed by the top wall 302a, the bottom wall 302b, and the side walls 302c and 302d on the base 302. As such, the port configuration identification system base securing features 240 on the EMI “finger”/cage 210a on the port 210 will provide a force towards the top wall 302a, the bottom wall 302b, and the side walls 302c and 302d on the base 302 in order to secure the port configuration identification system 300 to the switch device 200, as illustrated in FIG. 7B.

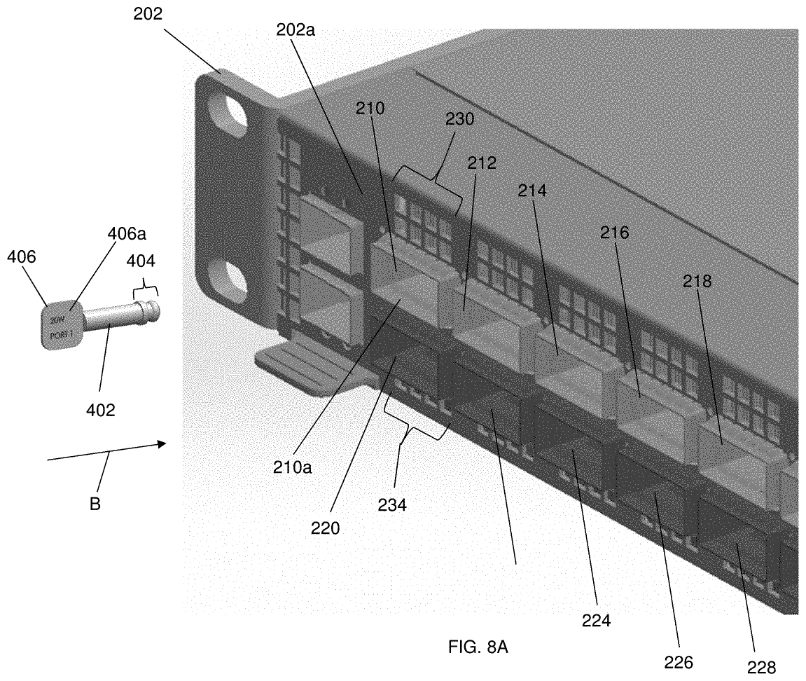

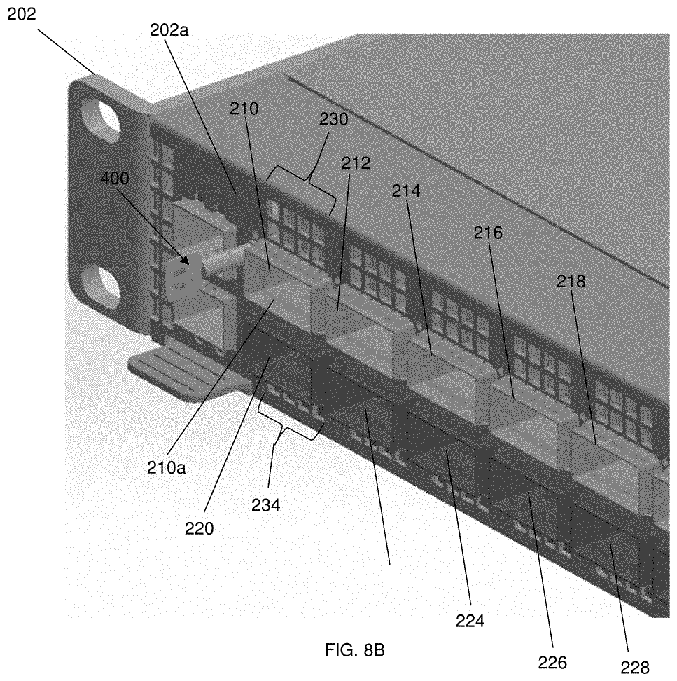

With reference to FIGS. 8A and 8B, in an embodiment of block 604, the port configuration identification system 400 discussed above with reference to FIG. 4 may be positioned (e.g., via a user grasping the handle 406 extending from the cylindrical base 402) adjacent the port 210 such that the device coupling feature 404 included on the cylindrical base 202 is aligned with one of the fourth subset of airflow apertures 236, as illustrated in FIG. 8A. The port configuration identification system 400 may then be moved towards that one of the fourth subset of airflow apertures 236 in a direction B such that the aperture engagement element 404a on the device coupling feature 404 enters and moves through that one of the fourth subset of airflow apertures 236 on the switch device 200 until the device stop member 404b on the device coupling feature 404 engages the front surface 202a of the switch device 200, which secures the port configuration identification system 400 to the switch device 200, as illustrated in FIG. 8B.

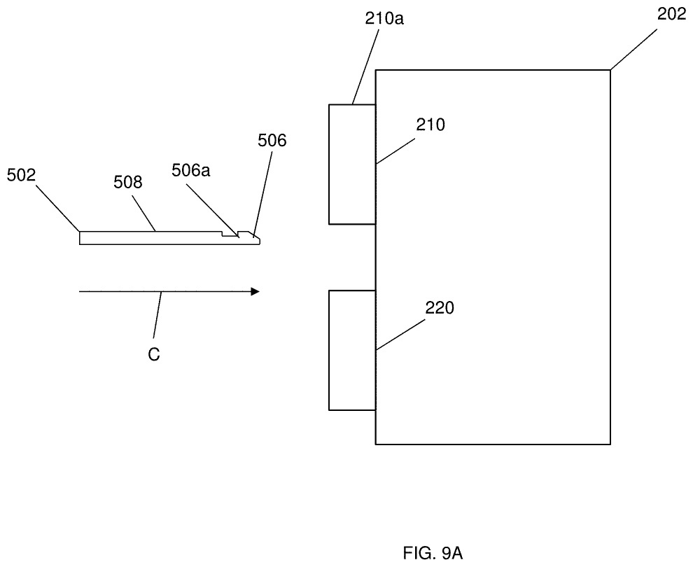

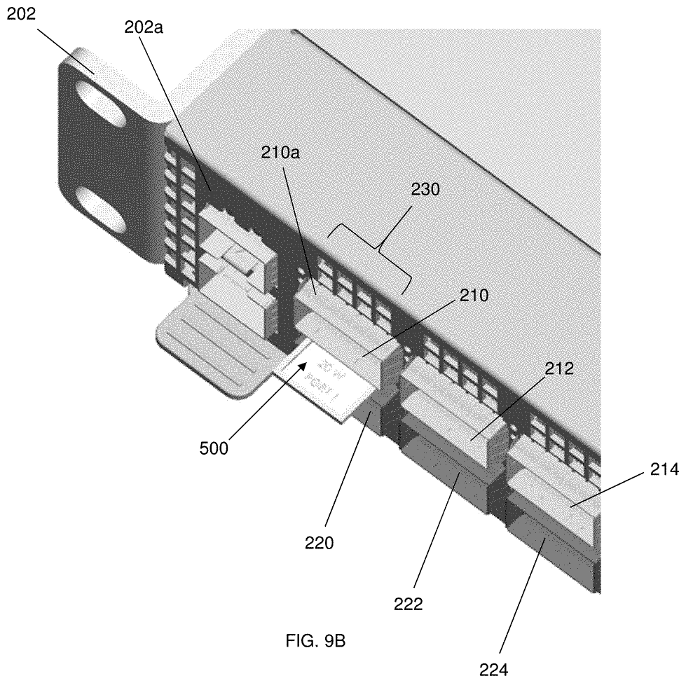

With reference to FIGS. 9A and 9B, in an embodiment of block 604, the port configuration identification system 500 discussed above with reference to FIG. 5 may be positioned (e.g., via a user grasping the base 502) adjacent the port 210 such that the aperture engagement elements 504 and 506 on the device coupling feature are aligned with respective ones of the second subset of airflow apertures 232 (e.g., airflow apertures on opposite sides of the top row of the 2×4 grid), as illustrated in FIG. 9A. The port configuration identification system 500 may then be moved towards those respective ones of the second subset of airflow apertures 232 in a direction C such that the aperture engagement elements 504 and 506 on the device coupling feature enter and move through those ones of the second subset of airflow apertures 232 on the switch device 200 until the securing features 504a and 506a on the aperture engagement elements 504 and 506, respectively, engage the front surface 202a of the switch device 200, which secures the port configuration identification system 500 to the switch device 200, as illustrated in FIG. 9B.

The method 600 then proceeds to block 606 where port configuration identification information on a port configuration identification surface that is included on the base identifies the port configuration of the port. With reference to FIG. 7B, in an embodiment of block 606 and with the port configuration identification system 300 secured to the switch device 200, the port configuration identification information surface 306a on the port configuration identification system 300 is positioned adjacent the port 210, allowing a user to identify the port configuration of the port 210 (e.g., that “PORT 1” is configured with a port power configuration that provides “20 W” power to a connected device). With reference to FIG. 8B, in an embodiment of block 606 and with the port configuration identification system 400 secured to the switch device 200, the port configuration identification information surface 406a on the port configuration identification system 400 is positioned adjacent the port 210, allowing a user to identify the port configuration of the port 210 (e.g., that “PORT 1” is configured with a port power configuration that provides “20 W” power to a connected device). With reference to FIG. 9B, in an embodiment of block 606 and with the port configuration identification system 500 secured to the switch device 200, the port configuration identification information surface 508 on the port configuration identification system 500 is positioned adjacent the port 210, allowing a user to identify the port configuration of the port 210 (e.g., that “PORT 1” is configured with a port power configuration that provides “20 W” power to a connected device). As such, one of skill in the art in possession of the present disclosure will appreciate how a user may utilize the port configuration identification systems 300, 400, or 500 to determine that a transceiver device (e.g., a QSFP-DD transceiver device that requires relatively higher power amounts) should be connected to the port 210 that is configured to provide a higher power amount as compared to the remaining ports 212-228 on the switch device 200.

Thus, systems and methods have been described that provide a flexible, easy to install/configure port configuration identification system that provides a visual aid for identifying port configurations of ports while not compromising (or substantially comprising) airflow to the port (or the device that includes the port). For example, the port configuration identification system of the present disclosure may include a base. A port configuration identification information surface is included on the base and includes port configuration identification information corresponding to a port configuration available for a port on a computing device. A computing device coupling feature is included on the base and is configured to couple to the computing device to secure the base relative to the computing device and adjacent the port such that the port configuration identification information surface is positioned adjacent the port. As such, the systems and methods of the present disclosure allow ports with different port configurations on a device to be identified without the limitations of conventional port configuration identification systems

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A port configuration identification system, comprising:
a base;
a port configuration identification information surface on the base that includes port configuration identification information identifying a number for a port on a computing device and a first amount of power the port on the computing device is configured to provide; and
a computing device coupling feature that is defined by the base, extends through the base, and that is configured to house a portion of the port while allowing the port to remain accessible to a transceiver device in order to secure the base relative to the computing device immediately adjacent the port such that the port configuration identification information is displayed immediately adjacent the port and all of the port configuration identification information is visible when a transceiver device is connected to the port.

2. (canceled)

3. The system of claim 1, wherein the portion of the port includes base securing features that are configured to engage opposite walls of the base when the portion of the port is housed in the computing device coupling feature defined by the base in order to secure the base relative to the computing device.

4. (canceled)

5. (canceled)

6. The system of claim 1, wherein the first amount of power the port on the computing device is configured to provide is different than a second amount of power that the port on the computing device is configurable to provide.

7. An Information Handling System (IHS), comprising:
a chassis;
a processing system that is housed in the chassis;
a port that is coupled to the processing system and that is accessible on a surface of the chassis; and
a port configuration identification system including:
a base;
a port configuration identification information surface on the base that includes port configuration identification information identifying a number for the port and a first amount of power the port is configured to provide; and
a chassis coupling feature that is defined by the base, extends through the base, and that houses a portion of the port while allowing the port to remain accessible to a transceiver device in order to secure the base relative to the chassis immediately adjacent the port such that the port configuration identification information is displayed immediately adjacent the port and all of the port configuration identification information is visible when a transceiver device is connected to the port.

8. (canceled)

9. (canceled)

10. The IHS of claim 7, wherein the portion of the port includes base securing features that are configured to engage opposite walls of the base when the portion of the port is housed in the chassis coupling feature defined by the base in order to secure the base relative to the computing device.

11. The IHS of claim 7, wherein the chassis port includes an ElectroMagnetic Interference (EMI) cage that provides the base securing features.

12. The IHS of claim 7, wherein the first amount of power the port is configured to provide is different than a second amount of power that the port is configurable to provide.

13. The IHS of claim 7, further comprising:
a transceiver device connected to the port.

14. A method for identifying a port configuration, comprising:
configuring a port on a computing device to provide a first amount of power;
coupling a computing device coupling feature on which is defined by a base of a port configuration identification system and extends through the base, to the port in order to house a portion of the port while allowing the port to remain accessible to a transceiver device, wherein the coupling a computing device coupling feature to the port secures the base relative to the computing device such that a port configuration identification information surface on the base is located immediately adjacent the port and all of the port configuration identification information is visible when a transceiver device is connected to the port;
identifying, by port configuration identification information that is included on the port configuration identification information surface such that the port configuration identification information is displayed immediately adjacent the port, a port number for the port and a first amount of power the port is configured to provide; and
connecting a transceiver device to the port based on the port configuration identification information.

15. The method of claim 14, wherein the coupling of the computing device coupling feature to the port includes handling the port configuration identification system using a tab that extends from the base.

16. The method of claim 14, wherein the portion of the port includes base securing features that engage opposite walls of the base when the portion of the port is housed in the computing device coupling feature defined by the base in order to secure the base relative to the computing device.

17. The method of claim 15, wherein the port includes an ElectroMagnetic Interference (EMI) cage that provides the base securing features.

18. The method of claim 14, wherein the computing device is a switch device.

19. The method of claim 14, wherein the first amount of power the port is configured to provide is different than a second amount of power the port is configurable to provide.

20. The method of claim 14, wherein the base on the port configuration identification system includes the same relative dimensions as the port.
